(19) United States
(12) Patent Application Publication
(10) Pub. No.: US 2005/0086175 A1
(43) Pub. Date: Apr. 21, 2005

(54) Method for storage and transport of an electronic certificate

(76) Inventors: Olivier Brique, Mont-sur-Lausanne (CH); Michael John Hill, Coppet (CH); Jimmy Cochard, Attalens (CH); Stephane Joly, Neuchatel (CH)

Correspondence Address: Supervisor, Patent Prosecution Services;Piper Rudnick, 1200 Nineteenth Street, N..W., Washington, DC, 20036-2412, US

(21) Appl. No.: 10/504,288

(22) PCT Filed: Feb. 7, 2003
(86) PCT No.: PCT/IB03/00436

(30) Foreign Application Priority Data
Feb. 12, 2002 (CH) 0233/02
Apr. 24, 2002 (CH) 0698/02

(51) Int. Cl. G06F 17/60

(52) U.S. Cl. 705/64; 705/1

(57) ABSTRACT

The aim of this invention is to assure the portability of an electronic certificate and the security of the private key which are part of the certificate X509. In fact, it is important that this certificate is not used for purposes uncontrolled by the holder, such as identity usurpation, the authorization of non-desired transactions or the reproduction of transactions (replay). This aim is reached by a storage and transporting method for an electronic certificate, said certificate having an authority section for the issuing authority, a holder section for the holder of the certificate and a signature section determined by the issuing authority, characterized in that all or part of the holder section is contained in a removable security module and that at least the authority section is contained in a host computer.

This invention concerns a storage and transport method for a X.509 type certificate.

The electronic certificate, like for example type X.509, is a collection of information for everything concerning the identification of a holder electronically. This certificate is given by an accredited authority that undertakes to identity the holder possessing such a certificate.

This is why, according to the level of undertaking of the authority giving the certificate, they can demand that the holder provides guarantees of his identity, for example that a notary confirms his identity.

This certificate is schematically composed of a part corresponding to the issuing authority and a part corresponding to the holder of the certificate, which is called “explicit”.

The part corresponding to the authority can be identical for all the certificates given by this authority. This part is called “implicit”.

To render these two parts inseparable, a certificate comprises a signature written on these two parts by means of the authority's private key.

When such a certificate is received from a storage server, the signature is verified thanks to the public key of the issuing authority. This key can be found in the certificate originating from the issuing authority. As indicated above, the signature allows one to verify the authenticity of the certificate's contents. These certificates are generally stored in a storage unit of a computer, as well as the root certificate, which is the certificate of the issuing authority.

There is thus an interest in disposing of a certificate stored on a removable support allowing the authentication module role to be used in this way.

For this reason, a simple diskette is sufficient to transport the certificate, support used at times to transmit such a certificate to a user.

Nevertheless this principle does not offer sufficient security for the storage of the private key, which is also necessary for on line transaction operations.

This is why the aim of this invention is to assure the portability of an electronic certificate and the security of the private key.

In fact, it is important that this certificate is not used for purposes uncontrolled by the holder, such as identity usurpation, the authorization of non-desired transactions or the reproduction of transactions (replay).

This aim is reached by a storage and transporting method for an electronic certificate, said certificate having an authority section for the issuing authority, a holder section for the holder of the certificate and a signature section determined by the issuing authority, characterized in that all or part of the holder section is contained in a removable security module and that at least the authority section is contained in a host computer.

This method also has the advantage of reducing the quantity of information stored in the security module. This module can have the form of a microchip card, a module with PCMCIA or USB interface, or even a transmission module without contact.

The transaction programmes on Internet require an authentication by a X.509 type certificate. It has been established that part of this certificate can be common to a large number of users and represents the section suitable for the authority (implicit) emitting such certificates.

It is thus advantageous, thanks to this invention, to store only the part suitable for each user (explicit) in the removable support, in our example this security module is a microchip card. This avoids a redundancy of data thus better use of the memory.

In fact, in these modules, data storage having contractual type contents is preferred such as the transactions carried out by the holder.

Although this certificate is fractionated, the signature of the issuing-authority on the ensemble of the authority sections and holder allows re-establishing the relation between these two entities.

Therefore if one of the two parts is modified, the unique image cannot be identical to the value of the calculated authentication with the public key of the issuing authority on this signature.

By signature, one understands the process that consists in determining a unique image of the data considered by this signature (by a Hash function for example) and encrypting this unique image by the private key of the entity which signs. The algorithm used for the establishment of this signature is an encryption of an asymmetrical type.

For verification of such a signature, one uses the public key of this entity to decipher the received signature and this value is compared with the result of the unique image carried out on the data to authenticate. If the deciphered value and the unique image are equal, the certificate is considered to be authentic and have data integrity.

The invention will be better understood thanks to the following detailed description, which refers to attached drawings, which are given as a non-limitative example, in which:

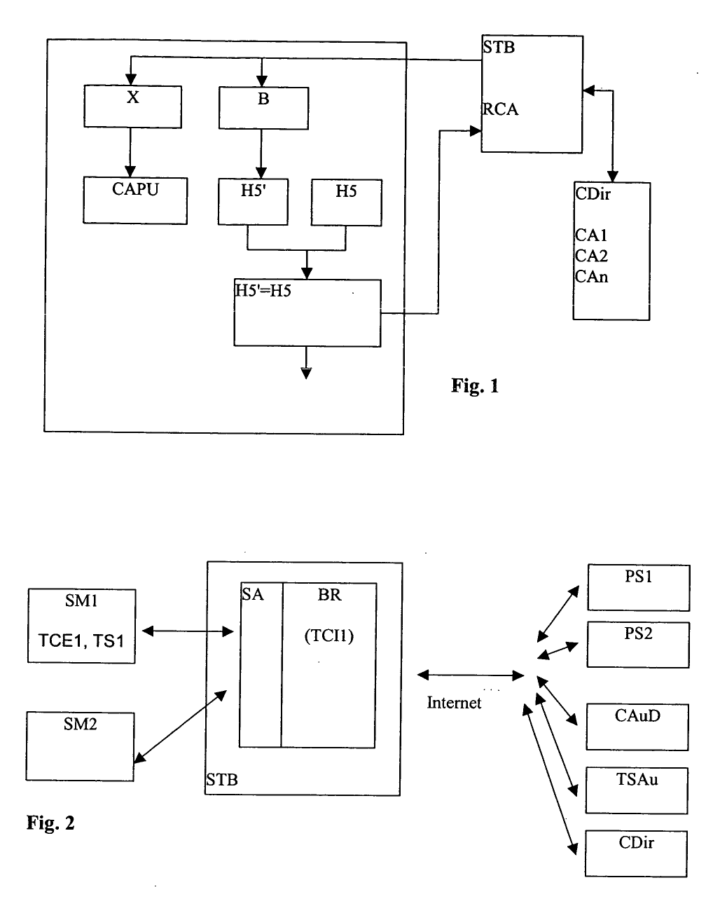

FIG. 1 represents the verification of the certificate of the issuing authority,

FIG. 2 represents the configuration showing the two parts of the certificate,

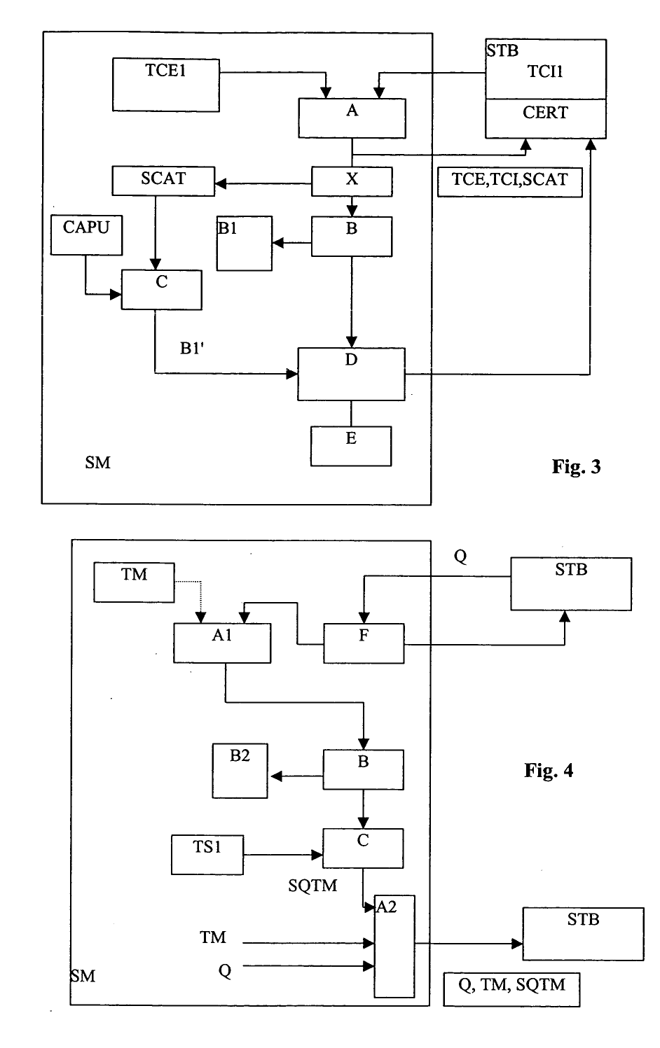

FIG. 3 represents the authentication of the reconstituted certificate,

FIG. 4 shows the processing method of a transaction,

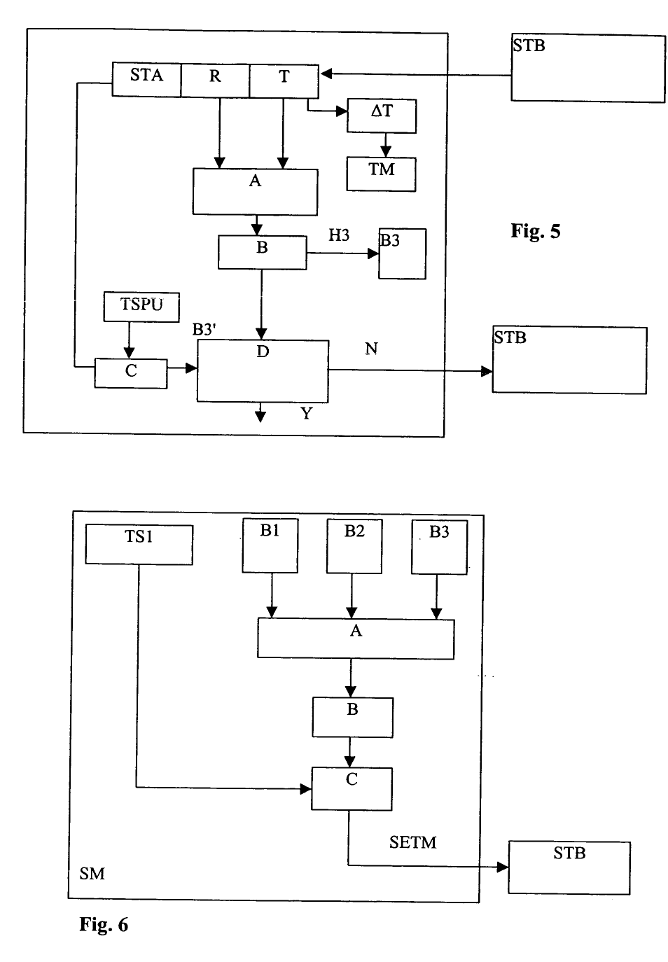

FIG. 5 represents the authentication method of the time,

FIG. 6 shows the conclusion signature on the data set,

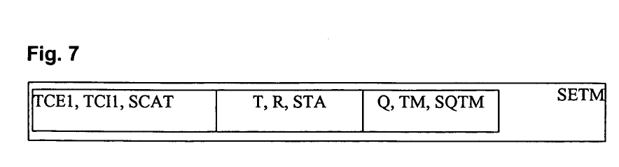

FIG. 7 shows the sent message.

FIG. 1 represents the extraction of the public key of the root certificate by the security module SM.

The root certificate RCA is the certificate of the issuing authority. This unit asks the STB host unit to send the RCA root certificate associated with the holder's certificate TCI1. This root certificate contains the public key CAPU of the issuing authority. This key allows authenticating the holder's reconstituted certificate with the implicit part and the explicit part of the holder's certificate. The STB host unit sends this root certificate to the security module SM to extract the public key CAPU. At the time of the installation of the holder's certificate in the security module, the latter conserves the image H5 that is the result of the Hash function on the root certificate RCA.

Concurrent with the extraction of the public key CAPU (see module X) the Hash function is carried out with the block B on the explicit and implicit data of the root certificate (explicit=part of the issuing authority, implicit =part of the authority having certified the issuing authority) and the result H5′ is compared to the referred value H5 initially stored. If the two values differ, the authentication operations are stopped and the host unit is informed.

When the two values H5 and H5′ are equal, the public key of the issuing authority is safeguarded and can be used for authentication operations of the holder's reconstituted certificate.

If the STB host unit does not dispose of the root certificate, it can make the request on the Internet network near for example to a site having a certificate directory (CDir) allowing access to desired certificates (CA1, CA2, CAn).

In FIG. 2, a first smart card SM1 is represented in which the explicit part TCE1 of the holder as well as its secret key TS1 are stored. Within the STB host unit, is access software to Internet BR currently called navigator.

With regard to the authentication functions, this programme has security software SA that carries out the interface with the smart card. It is also able to transmit the certificate in its whole and because of this, contains the data of the authority section TCI1.

The STB host unit is linked to the rest of the world by Internet for example to accede to the servers PS1, PS2, the sites to obtain the data of the issuing authority CauD, information about the time TSAu and the data about the root certificate directory CDir.

At the time of the transfer between the security module SM1 and the STB host unit, the data relating to the holder section TCEI are sent to the host unit according to a procedure starting at the security module preponderantly.

This operation will be described in more detail further on.

The verification of the integrity of this certificate is done with the process illustrated in FIG. 3. The multimedia unit or host unit, represented here with the STB block, transmits the data of the certificate contained in the destination host unit of the security module SM. For this purpose, if the “authority” part (implicit) is contained in its whole in the STB host unit, it is possible to store part of the “user” data (explicit) in the host unit too, the rest being placed in the security module SM.

Those data are organized in module A supplied on the one hand by the STB host unit, and on the other hand by data TCE1 of the memory of the security module. It is important to note here that the data TCE1 of the security module are not simply sent to the STB host unit for treatment but that there is the security module SM which controls the operation.

The data reconstituted by module A, are redirected towards the STB host unit and form the certificate CERT in view of being sent towards a service provider. Module A operates as a synchroniser and reconstructs the certificate according to the predefined format and disclosed by the composed block of elements TCE, TCI, SCAT.

In the certificate reconstituted in module A, one extracts the signature SCAT from the holder's certificate coming from the STB host unit (see module X).

The gathered data, excluding the signature SCAT, are sent to module B that has the task of determining a unique image from the assembly of those data.

This image is obtained by a Hash function (unidirectional and without collision) which is carried out on the data set in a precise order H=f (TCE1, TCI1). It is admitted that there does not exist any different data set, which gives the same result as this function. This image is produced by a unidirectional function and without Hash type collision. The used algorithm can be of type SHA-1 or MD5 and this image expresses the data set singularly.

The algorithm type to use is specified in the certificate. This image is safeguarded in module B1 for future use.

To verify if the two parts of the certificate are integral and authentic, the security module SM extracts the signature SCAT of the certificate and deciphers the latter in module C thanks to the public key of the authority CAPU.

For this operation, one considers the parameters contained in the certificate, which describe the kind of signature and the length of the keys.

In module D, the reference value B1′ is calculated and compared to the unique image B1. If the two values correspond, the certificate is authentic and can be used for future operations disclosed by module E. In negative, the smart card SM will refuse every transaction operation and will inform the STB host unit.

FIG. 4 shows the following operation, which consists in authorizing a transaction. If the previous test on the authentication of the certificate is positive (see modules D and E of FIG. 3) the STB host module can send the transaction signed to a server PS1, PS2.

A transaction Q can be filtered by module F of the security module SM, module that contains the acceptance rules. In fact, it is possible to determine a maximal amount or to enumerate a list of the institutes, which are accepted by the holder of the security module SM. These conditions can include a date of validity limit of the holder's certificate.

Once the transaction has successfully passed the filter of module F, it is presented at module B, which calculates a Hash function H2 on the assembly of the transaction Q. The result B2 is stored for subsequent use. This value H2 is then signed by the private key TS1 of the holder to form the transaction signature SQTM. Module A2 assembles the data of the transaction Q and the signature of the transaction SQTM to send it towards the STB host unit. According to a variant of the invention, it is possible to add, a validity limit of the transaction, which is schematised by the time TM to the transaction Q.

A way to determine this time is to use a time stamp T which can be the current time and to add the validity duration ?T. So this time TM is represented by: TM=T+?T.

This validity limit TM is added to transaction Q at the time of the determination of the Hash function in module B and at the time of the data set in module A2. When the transaction is received by the service supplier, it will verify that this limit is not passed.

According to a variant of the invention, the use of a validity limit TM can be made obligatory if a certain transaction amount is reached.

In FIG. 5 the authentication operation of the time furnished by the STB host unit is described. Those time data comprise the time T said, a random part R and a signature on the two previous data. The time stamp T as well as the random part R and the signature STA are transmitted to the security module SM. Starting with the time stamp T, one determines the validity limit TM by adding the validity duration ?T. This limit is used to define a maximum duration during which a transaction can be marked by this time.

The authentication is done in the same way as operations previously described, namely the calculation of a Hash function on the time stamp T and the random R in module B after their assembly in module A.

The intermediate result H3 is stored in module B3 for subsequent use.

For determination of the value B3′ (module C) one uses the key TSPU which is the public key of the authority giving the time.

When the key TSPU is not available in security module SM, a request is transmitted via the STB host unit to research the certificate relating to the issuing authority of the time T that contains this key.

One compares (module D) then this calculated value B3′ with the unique image B3 of the data T and R, to determine if the time is authentic.

In FIG. 6 the assembly operation of the certificate and the transaction as indicated, and optionally the time as well as other data relating to the transaction. The previous values B1 of the certificate, B2 of the transaction and B3 of the time are organized in module A and sent to module B to determine the Hash function. This value is then signed by the secret key of the holder TS1. The result is the signature SETM of the envelope the certificate assembly, transaction and time.

This envelope is shown in FIG. 7.

As the management of the memory is an important aspect in a security module, the signature of the encasing SETM is determined on the base of the values resulting from the Hash functions of each step. This way of proceeding allows linking all the data and guaranteeing that each part of the message has not been altered.

It would also be possible to calculate an encasing signature by taking each element separately and calculating the Hash function on these.

Nevertheless this method involves the memorization of the entire message to carry out this operation.

1-8. (canceled)

9. Storage and exploitation method by a host unit connected to a removable security module of an electronic certificate, said certificate having an authority section of the issuing authority, a holder section suitable for the holder of the certificate and a signature section determined by the issuing authority, wherein all or part of the holder section is contained in the removable security module and in that at least the authority section is contained in the host unit.

10. Storage and exploitation method of an electronic certificate according to claim 9, having the following steps:
transmitting the authority section to the security module,
reconstituting the certificate in the security module by assembling the holder section contained in the security module,
determining a unique image on the authority and holder sections,
deciphering the signature thanks to the public key of the issuing authority of the certificate to obtain a referred sure value,
comparing this referred value to the unique image of the authority and holder sections,
informing the host unit if the two values diverge and stopping the exploitation.

11. Method according to claim 10, wherein the security module deals with the data of a transaction to authorize according to the following steps:
reception of a transaction request by the security module,
filtering this transaction according to filtering parameters by a filtering module,
determination of a unique image of the accepted transaction and calculation of a signature by the private key of the holder,
transmission of the data of the transaction and the signature to the host unit.

12. Method according to claim 11, wherein it consists in adding to transaction a validity limit for determination of the unique image and the transaction signature and transmitting this validity limit with the data of the transaction and the transaction signature to the host unit.

13. Method according to claim 9, wherein the security module receives a time stamp and a random data which are signed by a certifying authority of the time and in that the security module authenticates the integrity of this information and informs the host unit if the exploitation can continue.

14. Method according to claim 13, wherein the removable security module generates the validity limit starting from the time stamp according to a duration of the security module.

15. Method according to claim 9, wherein the security module determines a general signature thanks to its private key on the unique images of the certificate of the transaction and of the temporary data.

16. Method according to claim 10, wherein the security module determines a general signature thanks to its private key on the unique images of the certificate of the transaction and of the temporary data.

17. Method according to claim 11, wherein the security module determines a general signature thanks to its private key on the unique images of the certificate of the transaction and of the temporary data.

18. Method according to claim 9, wherein the removable security module is a smart card.

19. Method according to claim 10, wherein the removable security module is a smart card.

20. Method according to claim 11, wherein the removable security module is a smart card.
